(19) United States
(12) Patent Application Publication
(10) Pub. No.: US 2016/0263541 A1
(43) Pub. Date: Sep. 15, 2016

(54) DEVICE FOR FEEDING GASIFICATION AGENT INTO A LOW-TEMPERATURE GASIFIER

(71) Applicant: LINDE AKTIENGESELLSCHAFT, München (DE)

(72) Inventors: Sven Halang, Frlberg (DE); Jens Buschmann, Dresden (DE); Ronald Meusel, Dresden (DE); Tomas Suchy, Halsbrücke (DE); Andreas Mihm, Dresden (DE)

(21) Appl. No.: 15/032,318

(22) PCT Filed: Oct. 30, 2014
(86) PCT No.: PCT/EP2014/002913

§ 371 Date: Apr. 27, 2016

(30) Foreign Application Priority Data
Nov. 13, 2013 (DE) 10 2013 018 992.6

(51) Int. Cl. B01J 7/00; C10J 3/24; C01B 3/02

(52) U.S. Cl. CPC B01J 7/00; C01B 3/02; C10J 3/24; C10J 2300/092; C10J 2200/152; C10J 2300/0956

(57) ABSTRACT

A device for supplying gasification agent to a reactor of a low-temperature gasifier, the device having at least one nozzle block joined at a first end by a pipe connection in a wall of the reactor to a manifold. Each nozzle block is located inside the reactor and the manifold is located outside the reactor. Each nozzle block includes at least two nozzle openings.

The invention relates to a device for feeding gasification agent into a low-temperature gasifier.

### PRIOR ART

Devices and processes for producing syngas from solid organic feedstock, also referred to as gasification processes are known. Coal or biomass is advantageously used as feedstock for such processes. In the case of biomass gasification processes, freshly harvested wood, old wood and residual forest wood or what is known as wood fuels are used for example, but also residual agricultural matter such as straw or chaff.

By gasifying biomass to form syngas with downstream process steps (known as biomass-to-liquids processes, BTL), it is possible for example to obtain synthetic biofuel, which is similar in its physicochemical properties to known gas-to-liquids (GTL) and coal-to-liquids (CTL) fuels. An example of a plant for producing BTL fuels is shown in Kiener, C. and Bilas, I.: Synthetischer Biokraftstoff der zweiten Generation. Weltweit erste kominerzielle BTL-Produktionsanlage [Synthetic second-generation biofuel. World's first commercial BTL production plant]. Energy 2.0, July 2008, pages 42-44.

Devices and processes for the at least partial gasification of solid organic feedstock are also known for example from EP 0 745 114 B1, DE 41 39 512 A1 and DE 42 09 549 A1. The present application relates here to those processes and devices that use a low-temperature gasifier, as explained below.

In a low-temperature gasifier, the feedstock, for example biomass, is reacted by partial gasification with a gasification agent, for example air, in particular oxygen, with a steam/carbon dioxide/nitrogen mixture, at temperatures of between about 300° C. and 800° C. and under pressures of 1-100 bar to form coke (in the case of biomass, what is known as biocoke) and low-temperature carbonization gas. The reaction is referred to as autothermal pyrolysis or else as “low-temperature carbonization”. As is known, low-temperature carbonization is distinguished by a substoichiometric oxygen supply, and thus incomplete combustion at a comparatively low temperature.

In the prior art, gasification agent is fed into a low-temperature gasifier by means of individual nozzles, which are each formed on a nozzle assembly, which is formed on an underside of the low-temperature gasifier and is made to pass through from the outside to the inside. The individual nozzles or nozzle assemblies are arranged in rows in the cross-sectional direction and multiple rows are arranged in the longitudinal direction in the low-temperature gasifier. This arrangement requires great effort in terms of production and maintenance.

A manifold for the gasification agent is located outside the low-temperature gasifier and requires connections for each individual nozzle or each individual nozzle assembly. This requires a complex construction and complex production of the manifold.

The object of the present invention is therefore to provide a feed of gasification agent into a low-temperature gasifier in an easy and effective way.

### DISCLOSURE OF THE INVENTION

This object is achieved by a device fir feeding gasification agent into a low-temperature gasifier with the features of patent claim 1.

### ADVANTAGES OF THE INVENTION

A device according to the invention has for feeding gasification agent at least one nozzle assembly, which at a first end is connected by way of connection piece in a wall of a reactor of a low-temperature gasifier to a manifold, the at least one nozzle assembly having at least two nozzle openings. This has the advantage that gasification agent that is fed to the low-temperature gasifier through the nozzle openings can be fed in an effective way directly in the required region, to what is known as the coke bed. This also ensures a simple construction and easy maintenance of the gasification agent feed, since the number of components and bushings through the wall of the reactor needed altogether is reduced in comparison with the prior art, since a nozzle assembly with a connection piece is not required for each individual nozzle opening.

The nozzle openings are advantageously formed as individual nozzles or as nozzle caps with multiple outlet openings and/or integrated restrictors. This makes a simple construction possible, and locationally exact metering when feeding the gasification agent.

It is of particular advantage if the at least one nozzle assembly extends from the connection piece to an opposite wall and/or abuts there. In particular, fastening of the second end of the nozzle assembly to the opposite wall can contribute to the stability, and consequently longevity, of the nozzle assembly. Consequently, a region filled with feedstock in the low-temperature gasifier is supplied uniformly with gasification agent and ensures good gasification.

The at least one nozzle assembly is preferably arcuately formed, the arc form substantially matching a correspondingly formed wall of the pyrolysis reactor. The distribution of the gasification agent in the coke bed is thus further improved.

Alternatively, the at least one nozzle assembly is formed as a straight pipe. This makes easy maintenance of the low-temperature gasifier and of the nozzle assembly possible, since it can be easily exchanged through a connection opening.

It is also of advantage if the at least one nozzle assembly is formed internally with at least two separate channels, which respectively lead to the nozzle openings. As a result, a separate feed of the constituents of the gasification agent is made possible. For example, in the region of the nozzle outlet openings, an oxidation gas such as oxygen may be carried in an inner channel and a moderator such as carbon dioxide/nitrogen and/or steam may be carried in a further channel surrounding the inner channel. This offers protection of the nozzle material from overheating while at the same time increasing the oxygen fraction.

Furthermore, the at least one nozzle assembly is advantageously formed with a thermally protective layer, in particular a ceramic material. This offers protection from thermal stress and protection from abrasion.

The nozzle assemblies are preferably distributed at substantially equal spacings in relation to one another over a length of the reactor. As a result, a uniform distribution of the gasification agent in the reactor or in its coke bed is ensured. This also allows an adaptation to different sizes of the reactor of the low-temperature gasifier.

It is finally of advantage if the nozzle assemblies can be individually activated by the common manifold. This makes it possible for the feed of gasification agent to be adapted to a different distribution of feedstock in the coke bed of the reactor of the low-temperature gasifier.

Further advantages and configurations of the invention are evident from the description and the accompanying drawing.

It goes without saying that the features mentioned above and still to be explained below can be used not only in the respectively specified combination but also in other combinations or on their own without departing from the scope of the present invention.

The invention is schematically represented in the drawing on the basis of exemplary embodiments and is described in detail below with reference to the drawing.

### DESCRIPTION OF THE FIGURES

FIG. 1 shows a low-temperature gasifier with a device for feeding gasification agent according to the prior art.

FIG. 2 shows a low-temperature gasifier with a device according to the invention for feeding gasification agent in a preferred configuration.

FIG. 3 shows a low-temperature gasifier with a device according to the invention for feeding gasification agent in a further preferred configuration.

### EMBODIMENTS OF THE INVENTION

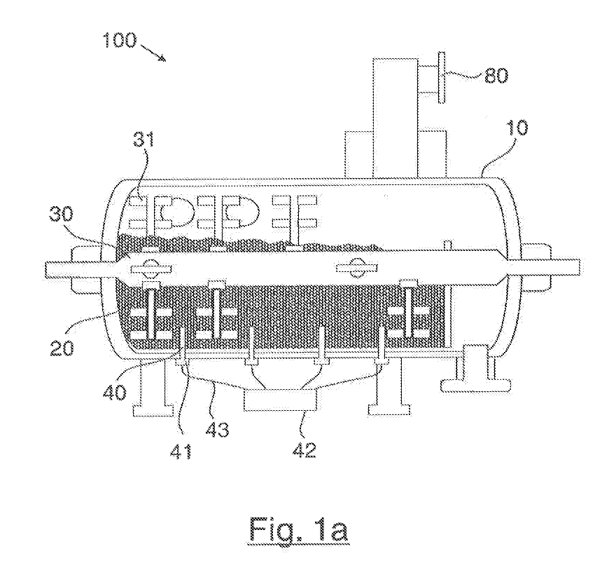

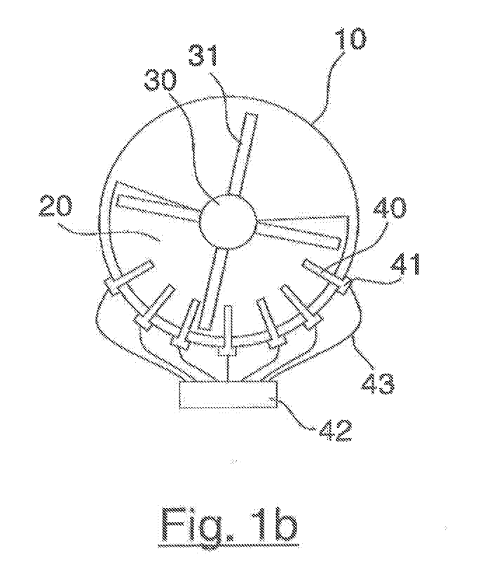

In FIG. 1, a low temperature gasifier 100 with a device for feeding gasification agent according to the prior art is schematically represented. View 1 (a) shows here a longitudinal section and view 1 (b) shows a cross section of the low-temperature gasifier 100. The following description applies to both views.

The low-temperature gasifier 100 comprises a reactor 10, formed by way of example as a cylinder, in which the autothermal pyrolysis/low-temperature carbonization takes place. A solid feedstock 20 is introduced into a lower region of the reactor 10. Formed in the reactor 10 is a mixing device 30, 31, which is intended for mixing the feedstock. By way of example, the mixing device 30, 31 is formed as a tube 30 that has been introduced centrally in the longitudinal direction, has multiple blades 31 attached to it and is rotatable about an axis, in particular the longitudinal axis, of the tube 30.

On the underside of the reactor 10, multiple nozzle assemblies 40 have been introduced into the tank 10 through connection openings 41. The nozzle assemblies 40 each have a nozzle opening at an end facing the interior of the reactor. In view 1 (a), four nozzle assemblies 40 are represented by way of example, provided at approximately equal spacings in relation to one another in the longitudinal direction of the reactor 10. These nozzle assemblies 40 respectively represent a row of nozzles in the transverse or circumferential direction of the reactor 10, as represented by way of example in view 1 (b) by seven nozzle assemblies 40.

Each of the nozzle assemblies 40 is connected on the outer side of the reactor 10 by way of connecting lines 43 to a manifold 42, through which the gasification agent is fed to the nozzle assemblies 40 and consequently to the low-temperature gasifier 100.

Also represented by way of example is an outlet opening 80 on a connection pipe, which is led upward from the reactor 10 and through which a low-temperature carbonization gas occurring during the pyrolysis can be carried out from the reactor 10 of the low-temperature gasifier 100.

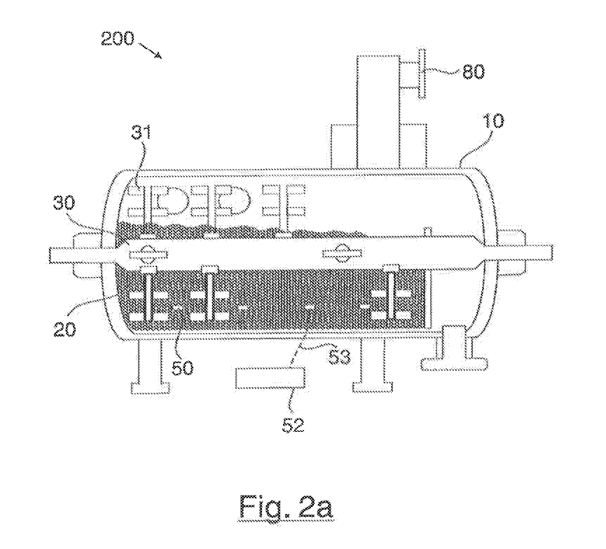

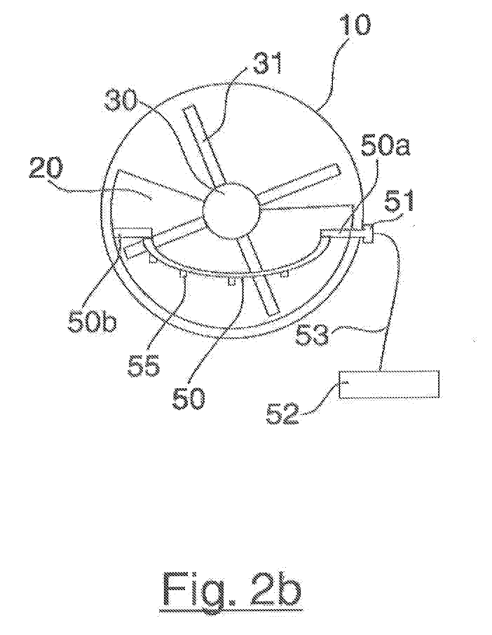

In FIG. 2, a temperature gasifier 200 with a device according to the invention for feeding gasification agent is schematically represented in a preferred configuration. View 2 (a) shows a longitudinal section and view 2 (b) shows a cross section of the low-temperature gasifier 200. The following description applies to both views.

The low-temperature gasifier 200 comprises a reactor 10, formed by way of example as a cylinder, in which the pyrolysis takes place. A solid feedstock 20 is introduced into a lower region of the reactor 10. Formed in the reactor 10 is a mixing device 30, 31, which is intended for mixing the feedstock. By way of example, the mixing device 30, 31 is formed as a tube 30 that has been introduced centrally in the longitudinal direction, has multiple blades 31 attached to it and is rotatable about an axis, in particular the longitudinal axis, of the tube 30.

In a lower region of the reactor 10, into which the feedstock 20 has been introduced, multiple nozzle assemblies 50 are formed. In the cross section according to view 2 (b) there can be seen a nozzle assembly 50, which is made to pass substantially from one side to another side of the reactor 10. In this case, at least at a first end 50a, the nozzle assembly 50 is made to pass with a connection piece 51 through a wall of the reactor 10, whereby it is connected to a manifold 52 on the outer side of the reactor 10. A second end 50b of the nozzle assembly 50 abuts an opposite wall region of the reactor 10 and is in particular fastened to this wall region.

In this configuration, the nozzle assemblies 50 are arcuately formed, so that the shape of the nozzle assemblies 50 approximately matches the shape of the lower, curved or arcuate, wall of the reactor 10. Along the nozzle assemblies 50, nozzle openings 55 are formed at an approximately equal spacing in relation to one another. By way of example, nine nozzle openings 55 on the nozzle assembly 50 are represented in view 2 (b). The nozzle openings 55 have in this case been introduced into the nozzle assembly 50 offset alternately in the circumferential direction of the nozzle assembly. This arrangement ensures a good distribution of the gasification agent in the feedstock 20. The distribution is also assisted by the arc form.

Each of the nozzle assemblies 50 is connected on the outer side of the reactor 10 by connecting lines 53 to a manifold 51, which is shared by all the nozzle assemblies 50 and through which the gasification agent is fed to the nozzle assemblies 50 and consequently through the nozzle openings 55 to the low-temperature gasifier 200. For the sake of overall clarity, in view 2 (a) a connecting line 53 is only represented by dashed lines.

Also represented by way of example is en outlet opening 80 on a connection pipe, which is led upward from the reactor 10 and through which a low-temperature carbonization gas occurring during the pyrolysis can be carried out from the reactor 10 of the low-temperature gasifier 200.

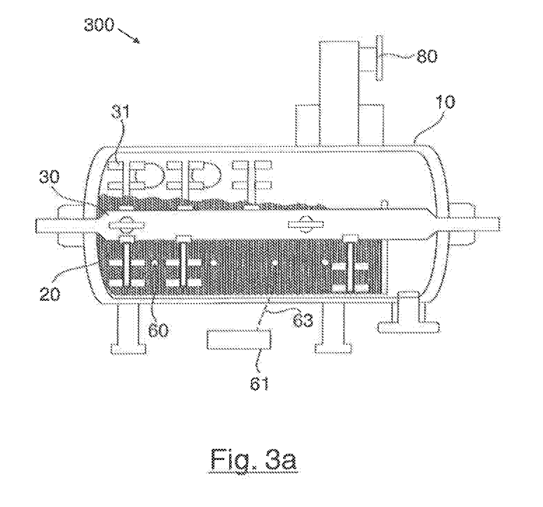

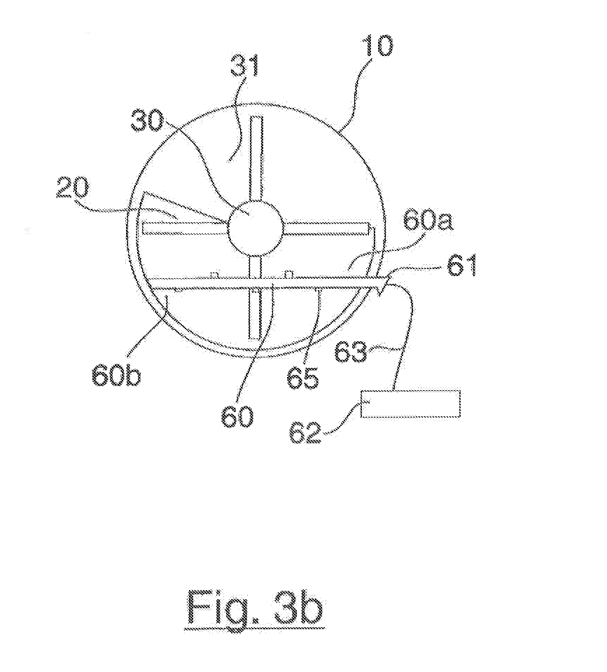

In FIG. 3, a temperature gasifier 300 with a device according to the invention for feeding gasification agent is schematically represented in a further preferred configuration. View 3 (a) shows a longitudinal section and view 3 (b) shows a cross section of the low-temperature gasifier 300. The following description applies to both views.

The low-temperature gasifier 300 comprises a reactor 10, formed by way of example as a cylinder, in which the pyrolysis takes place. A solid feedstock 20 is introduced in a lower region of the reactor 10. In the reactor 10 there is a mixing device 30, which is intended for mixing the feedstock. By way of example, the mixing device 30 is formed as a tube that has been introduced centrally in the longitudinal direction, has multiple blades attached to it and is rotatable about an axis of the tube.

In a lower region of the reactor 10, into which the feedstock 20 has been introduced, multiple nozzle assemblies 60 are formed. In the cross section according to view 3 (b) there can be seen a nozzle assembly 60, which is made to pass substantially from one side to another, in particular opposite, side of the tank 10. In this case, at least at a first end 60a, the nozzle assembly 60 is made to pass with a connection piece 61 through a wall of the tank 10, whereby it is connected to a manifold 62 on the outer side of the tank 10. A second end 60b of the nozzle assembly 60 abuts an opposite well region of the reactor 10 and is in particular fastened to this wall region.

In this configuration, the nozzle assemblies 60 are respectively formed as a straight pipe, so that the shape of the nozzle assemblies 60 forms with the lower, circularly arcuate, wall of the reactor 10 in cross section a segment of a circle. Along the nozzle assemblies 60, nozzle openings 65 are formed at an approximately equal spacing in relation to one another. The nozzle openings 65 have in this case been introduced into the nozzle

1. A device for feeding gasification agent into a reactor of a low-temperature gasifier for the thermal decomposition of fuels,
the device comprising at least one nozzle assembly, which at a first end is connected by way of a connection piece in a wall of the reactor to a manifold;
the at least one nozzle assembly being located inside the reactor and the manifold being located outside the tank,
characterized in that the at least one nozzle assembly has at least two nozzle openings.

2. The device as claimed in claim 1, the nozzle openings being formed as individual nozzles.

3. The device as claimed in claim 1, the nozzle openings being firmed as nozzle caps with multiple outlet openings or integrated restrictors.

4. The device as claimed in claim 1, the at least one nozzle assembly being arcuately formed.

5. The device as claimed in claim 1, the at least one nozzle assembly being formed as a straight pipe.

6. The device as claimed in claim 1, the at least one nozzle assembly abutting at a second end a wall of the reactor for mounting.

7. The device as claimed in claim 6, the at least one nozzle assembly extending from the connection piece substantially to an opposite wall of the reactor.

8. The device as claimed in claim 1, the at least one nozzle assembly having internally at least two separate channels, which are respectively led to the nozzle openings.

9. The device as claimed in claim 1, the at least one nozzle assembly being formed with a thermally protective layer.

10. The device as claimed in claim 9, the protective layer comprising a ceramic material.

11. The device as claimed in claim 1, the nozzle openings being arranged at substantially equal spacings along the at least one nozzle assembly.

12. The device as claimed in claim 1, the nozzle assemblies being distributed at substantially equal spacings in relation to one another over a length of the reactor.

13. The device as claimed in claim 1, the nozzle assemblies being individually activatable by the manifold.

14. The device as claimed in claim 1, the reactor of the low-temperature gasifier being configured for the thermal decomposition of fuels at temperatures of 300° C. to 800° C. and under pressures of 1 bar to 100 bar.
